(19) United States
(12) Patent Application Publication
(10) Pub. No.: US 2018/0189472 A1
(43) Pub. Date: Jul. 5, 2018

(54) VERIFYING WET INK SIGNATURES VIA DIGITAL PEN TECHNOLOGY

(71) Applicants: Prashant Dewan, Hillsboro, OR (US); Uttam K. Sengupta, Portland, OR (US); Ray Kacelenga, Forest Grove, OR (US)

(72) Inventors: Prashant Dewan, Hillsboro, OR (US); Uttam K. Sengupta, Portland, OR (US); Ray Kacelenga, Forest Grove, OR (US)

(21) Appl. No.: 15/395,671

(22) Filed: Dec. 30, 2016

(51) Int. Cl. G06F 21/36; G06F 21/32; G06F 21/60; G06K 9/00

(52) U.S. Cl. CPC G06F 21/36; G06F 21/32; G06F 21/602; G06Q 50/18; G06K 9/00154; G06K 9/00087; G06K 9/00892; G06F 21/606

(57) ABSTRACT

Systems, apparatuses and methods may provide for technology that includes a writing implement with an ink subsystem to print a message, a sensor subsystem to digitize the message and an authorization subsystem coupled to the sensor subsystem, wherein the authorization subsystem generates a notification of whether the digitized message is authentic. In one example, a remote server obtains the digitized message originating from a writing implement, wherein the digitized message includes an image of a handwritten signature and additional sensor information. In such a case, the server may conduct an authentication of the additional sensor information with respect to known sensor information associated with an authenticated user and send an authentication response to the writing implement based on the authentication.

### TECHNICAL FIELD

Embodiments generally relate to data security. More particularly, embodiments relate to verifying wet ink signatures via digital pen technology.

### BACKGROUND

Even with the development of e-signatures (electronic signatures), many financial and legal transactions such as the execution of closing disclosures, promissory notes, mortgages, security instruments, deeds of trust, rights to cancel, etc., may still call for handwritten (e.g., wet ink) signatures from the parties involved. The collection of handwritten signatures may be a tedious process, which may then be followed by additional manual procedures (e.g., scanning and creating electronic versions of the executed documents).

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration and block diagram of an example of a writing implement according to an embodiment;

FIG. 2A is a perspective cutaway view of an example of a writing implement according to an embodiment;

FIG. 2B is an end view of example of a writing implement according to an embodiment;

FIG. 3 is a flowchart of an example of a method of operating a writing implement according to an embodiment;

FIG. 4 is a flowchart of an example of a method of collecting information associated with a message according to an embodiment;

FIG. 5 is a flowchart of an example of a method of operating an authorization subsystem according to an embodiment;

FIG. 6 is an illustration of an example of a digitized message transaction architecture according to an embodiment;

FIG. 7 is a flowchart of an example of a method of operating a server according to an embodiment;

FIG. 8 is a block diagram of an example of a processor according to an embodiment; and

FIG. 9 is a block diagram of an example of a computing system according to an embodiment.

### DESCRIPTION OF EMBODIMENTS

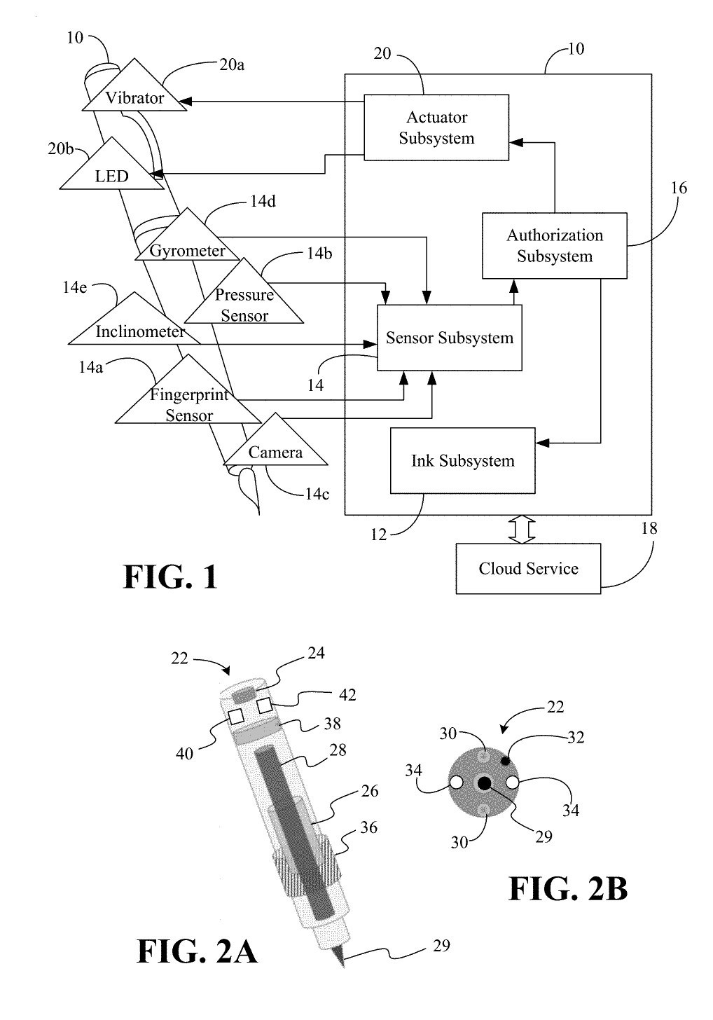

Turning now to FIG. 1, a security-enhanced writing implement 10 (e.g., pen, marker) is shown in which an ink subsystem 12 prints messages such as wet signatures and other handwritten content on paper or other suitable surface (e.g., fabric, walls, furniture) when operated/handled by an individual (e.g., user, author). The writing implement 10 might be used during a financial or legal transaction in which confirmation of the identity of the individual using the writing implement 10 is involved. For example, the individual may use the writing implement 10 to sign his or her name to various documents during a mortgage closing and/or property transfer.

The illustrated writing implement 10 also includes a sensor subsystem 14 (14a-14e) to digitize the message, wherein the sensor subsystem 14 may include, for example, a fingerprint sensor 14a to capture a fingerprint of the individual, a pressure sensor 14b to generate hand pressure (e.g., squeeze strength and/or downward force) measurement information, a camera 14c to capture an image of the message on paper, motion sensors such as a gyrometer 14d (e.g., gyroscope) and/or inclinometer 14e (e.g., accelerometer) to generate motion measurement information, and so forth. Thus, the digitized message may include the fingerprint, the hand pressure measurement information, the motion measurement information, the image and/or other parameters/meta-attributes of the handwriting activity. For example, the hand pressure measurement information may facilitate a determination of the thickness of the line drawn with the writing implement 10, since the thickness may be directly related to the amount of pressure applied. In one example, the sensor subsystem 14 is invoked by an interrupt from the pressure sensor 14b, although other approaches may be used.

As will be discussed in greater detail, an authorization subsystem 16 may be coupled to the sensor subsystem 14, wherein the authorization subsystem 16 generates a notification of whether the digitized message is authentic. In one example, the authorization subsystem 16 communicates the digitized message to a cloud service 18 (e.g., remote server or other peer in the cloud), which confirms whether the individual currently using the writing implement 10 is an authenticated user (e.g., known and/or previously registered). The illustrated writing implement 10 also includes an actuator subsystem 20 (20a, 20b) coupled to the authorization subsystem 16, wherein the actuator subsystem 20 outputs the notification as to whether the digitized message is authentic via a vibration component 20a and/or a light source 20b (e.g., light emitting diode/LED). For example, the vibration component 20a may physically oscillate and the light source 20b might emit green light if the authentication is successful (e.g., indicating that the individual has been verified), whereas the vibration component 20a may remain inactive and the light source 20b might emit a red light if the authentication is unsuccessful (e.g., indicating that the individual may be an imposter). Other actuation components such as, for example, speakers and/or chemical atomizers may also be used to output the results of the authentication.

Thus, if the individual is currently using the writing implement 10 to execute, for example, a deed of trust, the writing implement 10 may automatically interact with the cloud service 18 to determine whether the writing style (e.g., hand pressure, speed, tilt angle/direction) and/or other physical attributes (e.g., fingerprint) of the individual matches the known writing style of the individual who is supposed to be executing the deed of trust. Moreover, the actuator subsystem 20 may convey the results of the authentication in real-time to other individuals (e.g., attorneys, title officials) who are in the presence of the writing implement 10 by virtue of their ability to see the light source 20b. As will be discussed in greater detail, the cloud service 18 may also perform other activities such as applying the image of the message to an electronic version of the document being signed, as well as visually presenting the electronic document during application of the image to the electronic document.

FIGS. 2A and 2B show another example of a writing implement 22 that may be used to automatically authenticate users. In the illustrated example, a printed circuit board (PCB) 26 is positioned within a housing of the writing implement 22, wherein the PCB 26 may contain one or more semiconductor devices (e.g., integrated circuit/IC chips containing logic coupled to a silicon substrate, not shown) including an authorization subsystem such as, for example, the authorization subsystem 16 (FIG. 1) and/or a sensor subsystem such as, for example, the sensor subsystem 14 (FIG. 1), already discussed. The PCB 26 may also be powered by a battery (not shown) or other suitable power source. The PCB 26 may generate a digitized message containing an image of a message printed on paper by an ink well 28, wherein the image is captured by one or more camera sensors 30. As best shown in FIG. 2B, a tip 29 of the writing implement 22 may be equipped with an ambient light sensor 32 and one or more light sources 34 (LEDs) to illuminate the message on the writing surface (e.g., paper) during the capture of the image based on one or more signals from the ambient light sensor 32.

The digitized message may also include additional sensor information such as, for example, a fingerprint detected by a fingerprint sensor 36, motion measurement information generated by one or more motion sensors 38 (e.g., gyroscope, inclinometer, accelerometer), hand pressure measurement information generated by a pressure sensor (not shown), and so forth. The PCB 26 may encrypt and transmit the digitized message to a remote server via a communications antenna 24 (e.g., Bluetooth Low Energy/BLE antenna), wherein the remote server uses the unique attributes represented by the additional sensor information to conduct a real-time authentication of the digitized message. Of particular note is that the image and the motion measurement information may enable analysis of handwritten signatures without the use of special paper (e.g., with metered dots) or anchors on the writing surface to determine the coordinates of the writing instrument 22 during operation. The results of the authentication may be received via the communications antenna 24, wherein a notification of the results may be decrypted and output via a vibration component 40 and/or a light source 44.

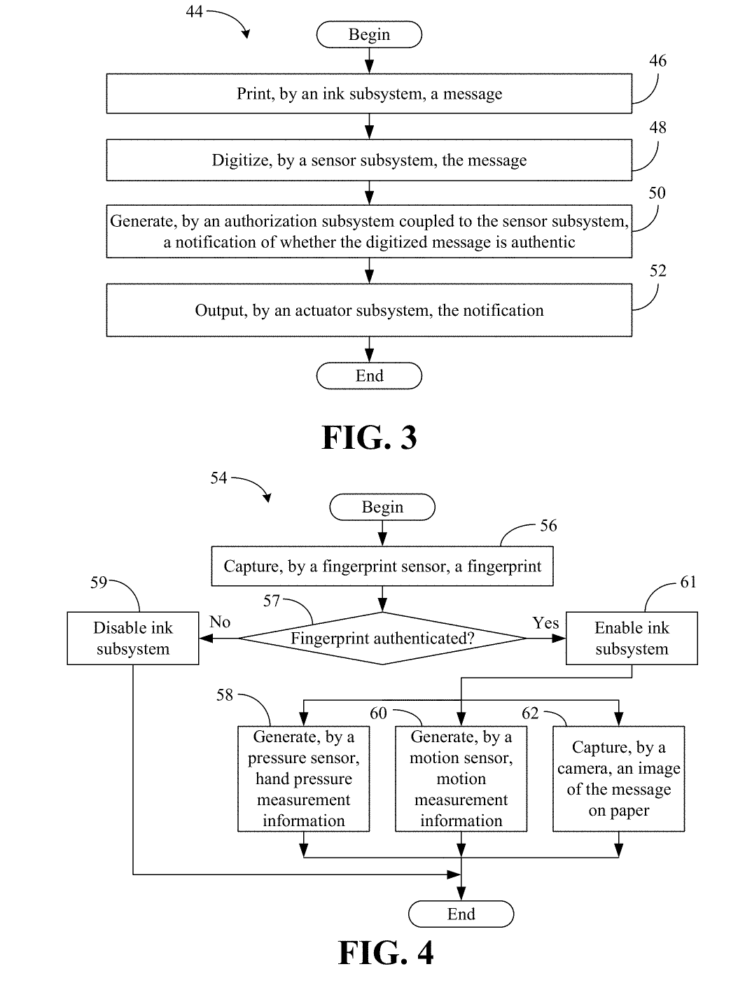

FIG. 3 shows a method 44 of operating a writing implement. The method 44 may generally be implemented in a writing implement such as, for example, the writing implement 10 (FIG. 1) and/or the writing implement 22 (FIGS. 2A and 2B), already discussed. More particularly, the method 44 may be implemented in one or more modules as a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 44 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 46 provides for printing, by an ink subsystem, a message. The message may include a handwritten/wet signature or other handwritten content printed on a surface lacking a coordinate anchor. Block 48 may digitize, by a sensor subsystem, the message, wherein illustrated block 50 generates, by an authorization subsystem, a notification of whether the digitized message is authentic. The notification may be output, by an actuator subsystem, at block 52 (e.g., via a vibration component, light source, etc.).

FIG. 4 shows a method 54 of collecting information associated with a message. The method 54 may generally be implemented in a writing implement such as, for example, the writing implement 10 (FIG. 1) and/or the writing implement 22 (FIGS. 2A and 2B), already discussed. More particularly, the method 54 may be implemented in one or more modules and/or sensors as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 56 captures, by a fingerprint sensor, a fingerprint. A determination may be made at block 57 as to whether authentication of the fingerprint has been successful. Block 57 may therefore include locally comparing the fingerprint to a previously stored fingerprint and/or incorporating the fingerprint into a digitized message communication to a remote server, which may compare the fingerprint to a previously stored fingerprint. Block 57 may therefore also include analyzing an authentication response from the remote server. If authentication of the fingerprint is unsuccessful, illustrated block 59 disables (e.g., deactivates) the ink subsystem prior to printing the message. Accordingly, the illustrated solution prevents usage of the writing implement by unauthorized individuals and provides an additional layer of security over signature matching in the cloud. If authentication of the fingerprint is successful, block 61 may enable (e.g., activate) the ink subsystem prior to printing the message. Blocks 59 and 61 may include selectively opening/closing valves, applying/removing power, etc., with respect to the ink subsystem. Additionally, block 58 may generate, by a pressure sensor, hand pressure measurement information. As already noted, line thickness determinations may be made based on the hand pressure measurement information. Illustrated block 60 generates, by a motion sensor, motion measurement information, wherein block 62 may capture, by a camera, an image of the message on paper. Block 62 may include illuminating, by a light source, the message on paper during capture of the image. Other sensor information may also be collected in order to support authentication.

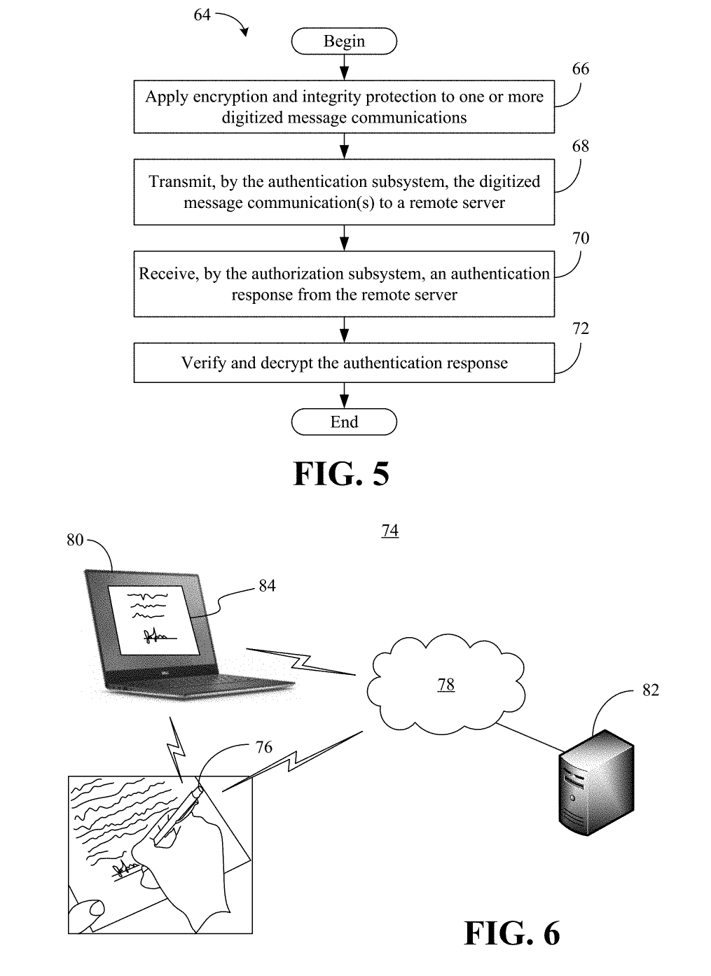

FIG. 5 shows a method 64 of operating an authorization subsystem. The method 64, which may be readily substituted for block 50 (FIG. 3), may generally be implemented in a writing implement such as, for example, the writing implement 10 (FIG. 1) and/or the writing implement 22 (FIGS. 2A and 2B), already discussed. More particularly, the method 64 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 66 provides for applying encryption (e.g., confidentiality) and integrity protection to one or more digitized message communications (e.g., packets), wherein the digitized message communication(s) may include an image of the handwritten message as well as additional sensor information (e.g., fingerprints, hand pressure measurements, motion measurements). With regard to integrity protection, digital signatures may be used between the endpoints (e.g., the writing implement and the remote server) to negotiate a symmetric key. Once both the endpoints have the symmetric key, they may perform key-hash message authentication code (HMAC) processing of the data passed in the channel to enforce/verify the integrity of the data received. The endpoints may also use counters to ensure that no malicious packet has been injected or a genuine packet dropped to ensure the integrity of the entire message and not just the individual packets. Block 68 may transmit, by the authentication subsystem, the digitized message communication(s) to a remote server, wherein illustrated block 70 receives, by the authentication subsystem, an authentication response from the remote server. Additionally, block 72 may verify the integrity and decrypt the content of the authentication response. End-to-end encryption and integrity protection of the communications may further protect against security breaches.

Turning now to FIG. 6, a digitized message transmission architecture 74 is shown. In the illustrated example, a user writes a message (e.g., handwritten signature) on a writing surface (e.g., paper) that lacks coordinate anchors (e.g., metered dots pre-printed on the paper). A writing implement 76 may wirelessly transmit a digitized message either directly (e.g., in a single hop) in one or more communications to a network 78 (e.g., Internet) or indirectly (e.g., in a multi-hop) in one or more communications to the network 78 via an intermediate computing device 80 (e.g., notebook computer, gateway), wherein the network 78 is in turn coupled to a remote server 82 (e.g., cloud service). In the single hop example, the writing implement 76 may also be equipped with a modem (not shown). The remote server 82 may generally conduct an authentication of the digitized message with respect to known sensor information associated with an authenticated user and return the results of the authentication to the writing implement 76 and/or the computing device 80.

Additionally, the remote server 82 may identify an electronic document 84 associated with the digitized message and visually present the electronic document 84 while applying the image of the message to the electronic document 84. Visual presentation of the electronic document 84 may take the form of sending HTML (Hypertext Markup Language) responses to the computing device 80 or other computing system, wherein the HTML responses include web pages containing the visual representations of the electronic document 84.

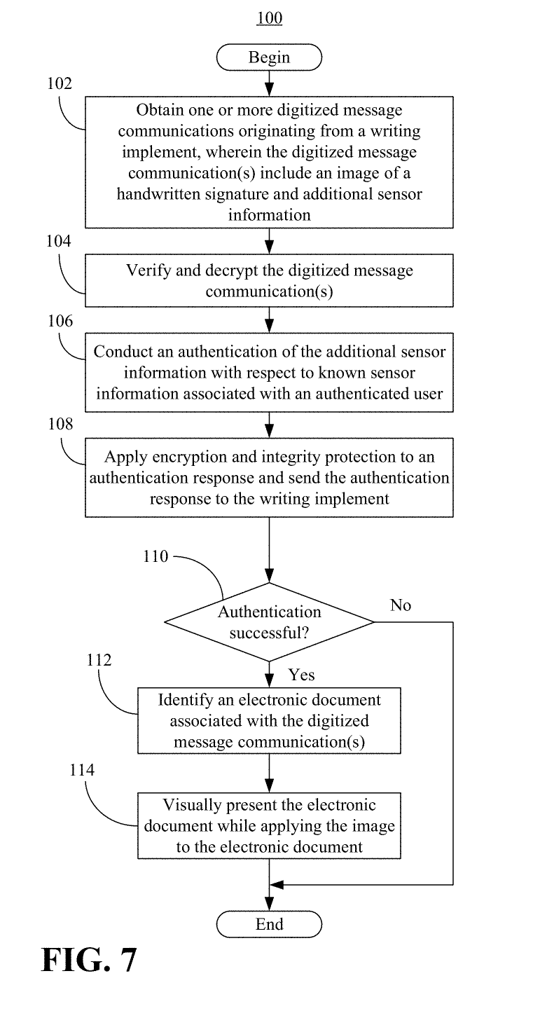

FIG. 7 shows a method 100 of operating a server. The method 100 may generally be implemented in a server such as, for example, the server 82 (FIG. 6), already discussed. More particularly, the method 100 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated block 102 provides for obtaining one or more digitized message communications originating from a writing implement, wherein the digitized message communication(s) include an image of a handwritten signature and additional sensor information. Additionally, the digitized message communication(s) may be verified and decrypted at block 104, wherein an authentication of the additional sensor information may be conducted at block 106 with respect to known sensor information associated with an authenticated user.

In general, block 106 may not recognize the image of the signature, but rather recognize the hand movements of the user during generation of the signature. For example, if the user makes a spline curve in ink, the action may be recorded, wherein the spline curve is reproduced digitally in the additional sensor information. In real-time, block 106 may compare the additional sensor information with the actions that the user previously performed while enrolling his/her signature.

More particularly, the motion sensor inside the writing implement may be used to identify the (X, Y) values of the curve (signature) made by the user. Block 106 may calculate δXₙ=(Xₙ−X₍ₙ₋₁₎), δYₙ=(Yₙ−Y₍ₙ₋₁₎) and conduct a linear regression of δXₙ, δYₙ with a known user curve or minimize the standard deviations across the two sets. This approach may be further optimized by recording the pressure applied by the user at X, Y coordinates.

Alternatively, block 106 may develop a match function F(Xₙ) and a loss function L(Xₙ), where the match function provides the deviation of various user test signatures from a trained pattern and the loss function provides the deviation of the user test signatures from the trained pattern of other user signatures in a database. The solution may ensure that L(Xₙ) is lower than a pre-decided value delta and F(Xn) is maximized.

Illustrated block 108 applies encryption and integrity protection to an authentication response and sends the authentication response to the writing implement based on the authentication. Additionally, a determination may be made at block 110 as to whether the authentication was successful (e.g., user verified). If so, block 112 may identify an electronic document (e.g., closing disclosure, promissory note, mortgage, security instrument, deed of trust, right to cancel, patent assignment/oath, etc.) associated with the digitized message. Block 112 may take into consideration the image, which may contain information about the paper document, depending on the field-of-view of the camera located inside the writing implement. For example, areas around the signature line might be captured and analyzed to determine which page is being written on. Additionally, a feedback look may be used to prompt the user for more information about the document.

The electronic document may be visually presented at block 114 while applying the image to the electronic document. Automatically applying the image to the electronic document may enable manual procedures such as scanning the paper document to be eliminated. Visually presenting the electronic document while applying the image may provide additional assurance to others that the individual signing the paper document is not an imposter. If it is determined at block 110 that the authentication was unsuccessful (e.g., user not verified), illustrated method 100 terminates without conducting blocks 112 or 114.

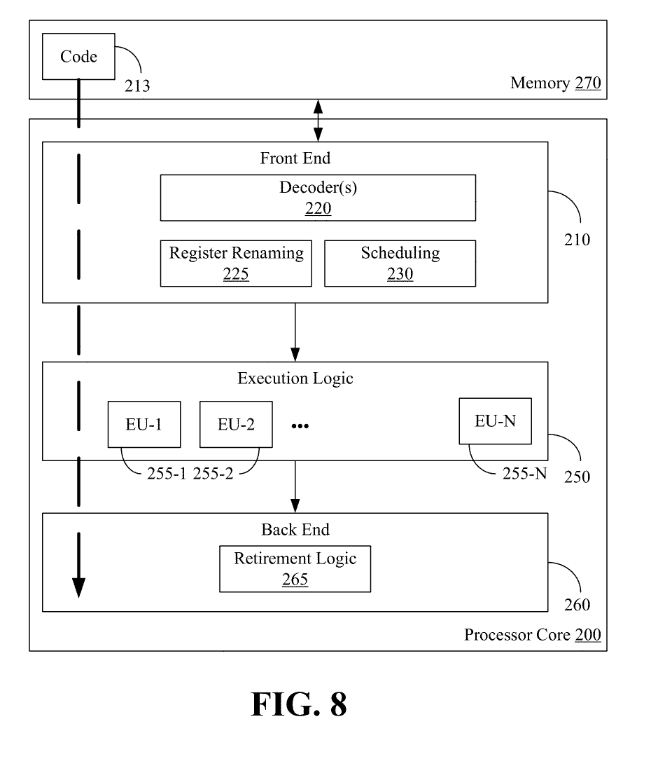

FIG. 8 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 8, a processing element may alternatively include more than one of the processor core 200 illustrated in FIG. 8. The processor core 200 may be a single-threaded core or, for at least one embodiment, the processor core 200 may be multithreaded in that it may include more than one hardware thread context (or “logical processor”) per core.

FIG. 8 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 44 (FIG. 3), the method 54 (FIG. 4), the method 64 (FIG. 5) and/or the method 100 (FIG. 7), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 8, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

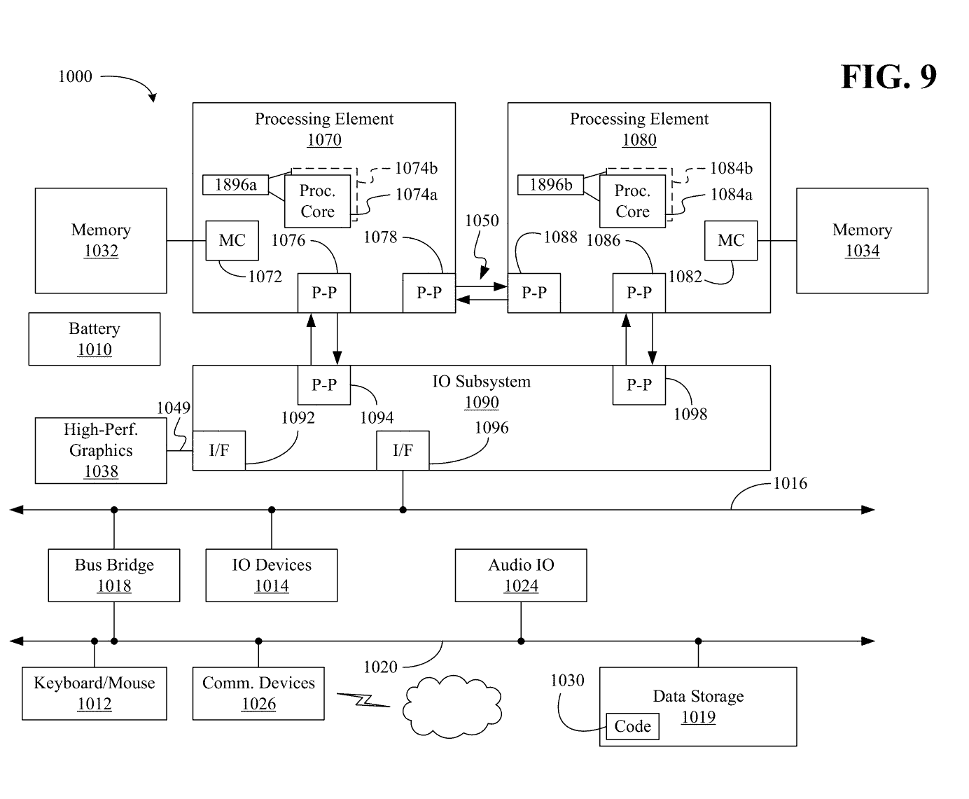

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 44 (FIG. 3), the method 54 (FIG. 4), the method 64 (FIG. 5) and/or the method 100 (FIG. 7), already discussed, and may be similar to the code 213 (FIG. 8), already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

Additional Notes and Examples:

Example 1 may include a security-enhanced writing implement comprising an ink subsystem to print a message, a sensor subsystem to digitize the message, and an authorization subsystem coupled to the sensor subsystem, the authorization subsystem to generate a notification of whether the digitized message is authentic.

Example 2 may include the writing implement of Example 1, wherein the sensor subsystem includes a fingerprint sensor to capture a fingerprint, a pressure sensor to generate hand pressure measurement information, a motion sensor to generate motion measurement information, a camera to capture an image of the message on paper, and a light source to illuminate the message on paper during the capture of the image, wherein the digitized message is to include one or more of the fingerprint, the hand pressure measurement information, the motion measurement information or the image.

Example 3 may include the writing implement of Example 2, wherein the authorization subsystem is to disable the ink subsystem prior to printing the message if authentication of the fingerprint is unsuccessful and enable the ink subsystem prior to printing the message if authentication of the fingerprint is successful.

Example 4 may include the writing implement of Example 1, wherein the authorization subsystem is to transmit the digitized message in one or more communications to a remote server and receive an authentication response from the remote server, and wherein the notification is to be generated based on the authentication response.

Example 5 may include the writing implement of Example 4, wherein the authorization subsystem is to apply encryption and integrity protection to the one or more digitized message communications prior to transmission of the one or more digitized message communications to the remote server, verify an integrity of the authentication response and decrypt the authentication response.

Example 6 may include the writing implement of Example 1, further including an actuator subsystem to output the notification via one or more of a vibration component or a light source.

Example 7 may include the writing implement of any one of Examples 1 to 6, wherein the message is to include a handwritten signature printed on a surface lacking a coordinate anchor.

Example 8 may include a method of operating a writing implement, comprising printing, by an ink subsystem, a message, digitizing, by a sensor subsystem, the message, and generating, by an authorization subsystem coupled to the sensor subsystem, a notification of whether the digitized message is authentic.

Example 9 may include the method of Example 8, further including capturing, by a fingerprint sensor, a fingerprint, generating, by a pressure sensor, hand pressure measurement information, generating, by a motion sensor, motion measurement information, capturing, by a camera, an image of the message on paper, and illuminating, by a light source, the message on paper during capture of the image, wherein the digitized message includes one or more of the fingerprint, the hand pressure measurement information, the motion measurement information or the image.

Example 10 may include the method of Example 9, further including disable the ink subsystem prior to printing the message if authentication of the fingerprint is unsuccessful, and enable the ink subsystem prior to printing the message if authentication of the fingerprint is successful.

Example 11 may include the method of Example 8, further including transmitting, by the authorization subsystem, the digitized message in one or more communications to a remote server, and receiving, by the authorization subsystem, an authentication response from the remote server, wherein the notification is generated based on the authentication response.

Example 12 may include the method of Example 11, further including applying encryption and integrity protection to the one or more digitized message communications prior to transmission of the one or more digitized message communications to the remote server, verifying an integrity of the authentication response, and decrypting the authentication response.

Example 13 may include the method of Example 8, further including outputting, by an actuator subsystem, the notification via one or more of a vibration component or a light source.

Example 14 may include the method of any one of Examples 8 to 13, wherein the message includes a handwritten signature printed on a surface lacking a coordinate anchor.

Example 15 may include a method of operating a server, comprising obtaining one or more digitized message communications originating from a writing implement, wherein the one or more digitized message communications include an image of a handwritten signature and additional sensor information, conducting an authentication of the additional sensor information with respect to known sensor information associated with an authenticated user, and sending an authentication response to the writing implement based on the authentication.

Example 16 may include the method of Example 15, further including identifying an electronic document associated with the one or more digitized message communications, and applying the image to the electronic document if the authentication is successful.

Example 17 may include the method of Example 16, further including visually presenting the electronic document during application of the image to the electronic document.

Example 18 may include the method of Example 15, wherein the additional sensor information includes one or more of a fingerprint, hand pressure measurement information or motion measurement information.

Example 19 may include the method of any one of Examples 15 to 18, further including verifying an integrity of the one or more digitized message communications, decrypting the one or more digitized message communications, and applying encryption and integrity protection to the authentication response.

Example 20 may include at least one computer readable storage medium comprising a set of instructions, which when executed by a computing system, cause the computing system to obtain one or more digitized message communications originating from a writing implement, wherein the one or more digitized message communications include an image of a handwritten signature and additional sensor information, conduct an authentication of the additional sensor information with respect to known sensor information associated with an authenticated user, and send an authentication response to the writing implement based on the authentication.

Example 21 may include the at least one computer readable storage medium of Example 20, wherein the instructions, when executed, cause the computing system to identify an electronic document associated with the one or more digitized message communications, and apply the image to the electronic document if the authentication is successful.

Example 22 may include the at least one computer readable storage medium of Example 21, wherein the instructions, when executed, cause the computing system to visually present the electronic document during application of the image to the electronic document.

Example 23 may include the at least one computer readable storage medium of Example 20, wherein the additional sensor information is to include one or more of a fingerprint, hand pressure measurement information or motion measurement information.

Example 24 may include the at least one computer readable storage medium of any one of Examples 20 to 23, wherein the instructions, when executed, further cause the computing system to verify an integrity of the one or more digitized message communications, decrypt the one or more digitized message communications, and applying encryption and integrity protection to the authentication response.

Example 25 may include a server comprising means for obtaining one or more digitized message communications originating from a writing implement, wherein the one or more digitized message communications include an image of a handwritten signature and additional sensor information, means for conducting an authentication of the additional sensor information with respect to known sensor information associated with an authenticated user, and means for sending an authentication response to the writing implement based on the authentication.

Example 26 may include the server of Example 25, further including means for identifying an electronic document associated with the digitized message, and means for applying the image to the electronic document if the authentication is successful.

Example 27 may include the server of Example 26, further including means for visually presenting the electronic document during application of the image to the electronic document.

Example 28 may include the server of Example 25, wherein the additional sensor information is to include one or more of a fingerprint, hand pressure measurement information or motion measurement information.

Example 29 may include the server of any one of Examples 25 to 28, further including means for verifying an integrity of the one or more digitized message communications, means for decrypting the one or more digitized message communications, and means for applying encryption and integrity protection to the authentication response.

Thus, technology described herein may bridge the gap between wet ink signatures and digital signatures. The writing implement may continuously authenticate the user without the use of a smart phone, personal computer (PC), table computer, notebook computer, and so forth. Additionally, the coordinates of the writing implement on the writing surface may be tracked without involving the use of a marker or reference point printed on the writing surface.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A writing implement comprising:
an ink subsystem to print a message;
a sensor subsystem to digitize the message; and
an authorization subsystem coupled to the sensor subsystem, the authorization subsystem to generate a notification of whether the digitized message is authentic.

2. The writing implement of claim 1, wherein the sensor subsystem includes:
a fingerprint sensor to capture a fingerprint;
a pressure sensor to generate hand pressure measurement information;
a motion sensor to generate motion measurement information;
a camera to capture an image of the message on paper; and
a light source to illuminate the message on paper during the capture of the image, wherein the digitized message is to include one or more of the fingerprint, the hand pressure measurement information, the motion measurement information or the image.

3. The writing implement of claim 2, wherein the authorization subsystem is to disable the ink subsystem prior to printing the message if authentication of the fingerprint is unsuccessful and enable the ink subsystem prior to printing the message if authentication of the fingerprint is successful.

4. The writing implement of claim 1, wherein the authorization subsystem is transmit the digitized message in one or more communications to a remote server and receive an authentication response from the remote server, and wherein the notification is to be generated based on the authentication response.

5. The writing implement of claim 4, wherein the authorization subsystem is to apply encryption and integrity protection to the one or more digitized message communications prior to transmission of the one or more digitized message communications to the remote server, verify an integrity of the authentication response and decrypt the authentication response.

6. The writing implement of claim 1, further including an actuator subsystem to output the notification via one or more of a vibration component or a light source.

7. The writing implement of claim 1, wherein the message is to include a handwritten signature printed on a surface lacking a coordinate anchor.

8. A method of operating a writing implement, comprising:
printing, by an ink subsystem, a message;
digitizing, by a sensor subsystem, the message; and
generating, by an authorization subsystem coupled to the sensor subsystem, a notification of whether the digitized message is authentic.

9. The method of claim 8, further including:
capturing, by a fingerprint sensor, a fingerprint;
generating, by a pressure sensor, hand pressure measurement information;
generating, by a motion sensor, motion measurement information;
capturing, by a camera, an image of the message on paper; and
illuminating, by a light source, the message on paper during capture of the image, wherein the digitized message includes one or more of the fingerprint, the hand pressure measurement information, the motion measurement information or the image.

10. The method of claim 9, further including:
disable the ink subsystem prior to printing the message if authentication of the fingerprint is unsuccessful; and
enable the ink subsystem prior to printing the message if authentication of the fingerprint is successful.

11. The method of claim 8, further including:
transmitting, by the authorization subsystem, the digitized message in one or more communications to a remote server; and
receiving, by the authorization subsystem, an authentication response from the remote server, wherein the notification is generated based on the authentication response.

12. The method of claim 11, further including:
applying encryption and integrity protection to the one or more digitized message communications prior to transmission of the one or more digitized message communications to the remote server;
verifying an integrity of the authentication response; and
decrypting the authentication response.

13. The method of claim 8, further including outputting, by an actuator subsystem, the notification via one or more of a vibration component or a light source.

14. The method of claim 8, wherein the message includes a handwritten signature printed on a surface lacking a coordinate anchor.

15. A method of operating a server, comprising:
obtaining one or more digitized message communications originating from a writing implement, wherein the one or more digitized message communications include an image of a handwritten signature and additional sensor information;
conducting an authentication of the additional sensor information with respect to known sensor information associated with an authenticated user; and
sending an authentication response to the writing implement based on the authentication.

16. The method of claim 15, further including:
identifying an electronic document associated with the one or more digitized message communications; and
applying the image to the electronic document if the authentication is successful.

17. The method of claim 16, further including visually presenting the electronic document during application of the image to the electronic document.

18. The method of claim 15, wherein the additional sensor information includes one or more of a fingerprint, hand pressure measurement information or motion measurement information.

19. The method of claim 15, further including:
verifying an integrity of the one or more digitized message communications;
decrypting the one or more digitized message communications; and
applying encryption and integrity protection to the authentication response.

20. At least one computer readable storage medium comprising a set of instructions, which when executed by a computing system, cause the computing system to:
obtain one or more digitized message communications originating from a writing implement, wherein the one or more digitized message communications include an image of a handwritten signature and additional sensor information;
conduct an authentication of the additional sensor information with respect to known sensor information associated with an authenticated user; and
send an authentication response to the writing implement based on the authentication.

21. The at least one computer readable storage medium of claim 20, wherein the instructions, when executed, cause the computing system to:
identify an electronic document associated with the one or more digitized message communications; and
apply the image to the electronic document if the authentication is successful.

22. The at least one computer readable storage medium of claim 21, wherein the instructions, when executed, cause the computing system to visually present the electronic document during application of the image to the electronic document.

23. The at least one computer readable storage medium of claim 20, wherein the additional sensor information is to include one or more of a fingerprint, hand pressure measurement information or motion measurement information.

24. The at least one computer readable storage medium of claim 20, wherein the instructions, when executed, further cause the computing system to:
verify an integrity of the one or more digitized message communications;
decrypt the one or more digitized message communications; and
applying encryption and integrity protection to the authentication response.
